(19) United States
(12) Patent Application Publication
(10) Pub. No.: US 2015/0185442 A1
(43) Pub. Date: Jul. 2, 2015

(54) IMAGING LENS AND IMAGING UNIT

(71) Applicant: SONY CORPORATION, TOKYO (JP)

(72) Inventors: DAIGO KATSURAGI, KANAGAWA (JP); KENSHI NABETA, KUMAMOTO (JP)

(21) Appl. No.: 14/570,207

(22) Filed: Dec. 15, 2014

(30) Foreign Application Priority Data
Dec. 26, 2013 (JP) 2013-268399

(51) Int. Cl. G02B 13/00; H04N 5/225; G02B 9/60

(52) U.S. Cl. CPC G02B 13/0045; G02B 9/60; H04N 5/2254

(57) ABSTRACT

An imaging lens includes: a first lens having positive refractive power; a second lens having negative refractive power near an optical axis; a third lens having an object-sided surface that is a convex surface near the optical axis, the third lens having positive refractive power near the optical axis; a fourth lens having one of positive refractive power and negative refractive power near the optical axis; and a fifth lens having positive refractive power near the optical axis. The first to fifth lenses are arranged in order from an object side. The following Conditional expression (1) is satisfied,

v4<40 (1)

where v4 is an Abbe number of the fourth lens.

### CROSS REFERENCE TO RELATED APPLICATION

This application claims the benefit of Japanese Priority Patent Application JP 2013-268399 filed December 26, 2013, the entire contents of which are incorporated herein by reference.

### BACKGROUND

The present disclosure relates to an imaging lens that forms an optical image of a subject on an imaging device such as a CCD (Charged Coupled Device) or a CMOS (Complementary Metal Oxide Semiconductor). The present disclosure also relates to an imaging unit that is provided with the imaging lens to perform shooting. Examples of the imaging unit may include those applied to a digital still camera, a mobile phone provided with a camera, and an information mobile terminal.

Year after year, a thinner digital still camera such as that of a card type has been manufactured, and reduction in size of an imaging unit has been desired. Also, the reduction in size of the imaging unit has been desired also in a mobile phone in order to reduce thickness of a terminal itself or in order to secure a space for providing multiple functions. Accordingly, demand has been increased for further reduction in size of the imaging lens provided in the imaging unit.

Also, the number of pixels has been increased as a result of reduction in pixel pitch in the imaging device such as a CCD and a CMOS at the same time as reduction in size of the imaging device. Accordingly, a high performance has been demanded for the imaging lens used in these imaging units.

High resolving power is demanded for the imaging lens used in the imaging device having higher resolution as described above. However, the resolving power is limited by an F-number. Because a lens having a brighter F-number achieves higher resolving power, a sufficient performance has not been achieved with the F-number of about F2.8. Accordingly, there has been demanded an imaging lens that has brightness of about F2 that is suitable for the imaging device that has increased number of pixels, higher resolution, and smaller size. As the imaging lens for such an application, there has been proposed an imaging lens having a five-lens configuration that achieves larger aperture ratio and higher performance compared with a lens having a three-lens configuration or a four-lens configuration (see Japanese Unexamined Patent Application Publication No. 2009-294527 (JP2009-294527A) and US Patent Application Publication No. 2010/0315723 (US2010/0315723A)).

For example, the imaging lens having the five-lens configuration disclosed in JP2009-294527A includes: in order from an object side, a first lens having an object-sided surface that is a convex surface and having positive power; a second lens having an image-sided surface that is a concave surface near an optical axis and having negative power near the optical axis; a third lens having an image-sided surface that is a convex surface near the optical axis and having positive power near the optical axis; an aspherical fourth lens having an image-sided surface that has a concave shape near the optical axis and has a convex shape in a peripheral portion thereof; and a fifth lens having positive power near the optical axis.

### SUMMARY

Recently, in order to achieve an imaging lens suitable for an imaging device having the increased number of pixels, it has been desired to develop, as an imaging lens, a lens system that achieves reduction in total length and has a higher image formation performance in a range from a center angle of view to a peripheral angle of view. The imaging lenses having the five-lens configuration disclosed in JP2009-294527A and US2010/0315723A described above are still insufficient in performance in terms of reduction in optical length, correction of chromatic aberration and field curvature, etc., and there is still a room for improvement therein. It is desirable to provide an imaging lens and an imaging unit that are capable of favorably correcting various aberrations while being compact.

According to an embodiment of the present disclosure, there is provided an imaging lens including: a first lens having positive refractive power; a second lens having negative refractive power near an optical axis; a third lens having an object-sided surface that is a convex surface near the optical axis, the third lens having positive refractive power near the optical axis; a fourth lens having one of positive refractive power and negative refractive power near the optical axis; and a fifth lens having positive refractive power near the optical axis. The first to fifth lenses are arranged in order from an object side. The following Conditional expression (1) is satisfied,

v4<40 (1)

where v4 is an Abbe number of the fourth lens.

According to an embodiment of the present disclosure, there is provided an imaging unit including: an imaging lens; and an imaging device configured to output an imaging signal based on an optical image formed by the imaging lens. The imaging lens includes: a first lens having positive refractive power; a second lens having negative refractive power near an optical axis; a third lens having an object-sided surface that is a convex surface near the optical axis, the third lens having positive refractive power near the optical axis; a fourth lens having one of positive refractive power and negative refractive power near the optical axis; and a fifth lens having positive refractive power near the optical axis. The first to fifth lenses are arranged in order from an object side. The following Conditional expression (1) is satisfied,

v4<40 (1)

where v4 is an Abbe number of the fourth lens.

In the imaging lens or the imaging unit according to the embodiment of the present disclosure, the five-lens configuration is achieved as a whole, and configurations of the respective lenses are optimized.

According to the imaging lens or the imaging unit according to the embodiment of the present disclosure, the five-lens configuration is achieved as a whole, and configurations of the respective lenses are optimized. As a result, it is possible to favorably correct various aberrations while achieving compactness. It is to be noted that effects of the present disclosure is not limited to the effect described above and may be any of the effects disclosed in the present disclosure.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a lens cross-sectional view illustrating a first configuration example of an imaging lens according to an embodiment of the present disclosure.

FIG. 2 is an aberration diagram illustrating various aberrations in Numerical example 1 in which specific numerical values are applied to the imaging lens illustrated in FIG. 1.

FIG. 3 is a lens cross-sectional view illustrating a second configuration example of the imaging lens.

FIG. 4 is an aberration diagram illustrating various aberrations in Numerical example 2 in which specific numerical values are applied to the imaging lens illustrated in FIG. 3.

FIG. 5 is a lens cross-sectional view illustrating a third configuration example of the imaging lens.

FIG. 6 is an aberration diagram illustrating various aberrations in Numerical example 3 in which specific numerical values are applied to the imaging lens illustrated in FIG. 5.

FIG. 7 is a lens cross-sectional view illustrating a fourth configuration example of the imaging lens.

FIG. 8 is an aberration diagram illustrating various aberrations in Numerical example 4 in which specific numerical values are applied to the imaging lens illustrated in FIG. 7.

FIG. 9 is a lens cross-sectional view illustrating a fifth configuration example of the imaging lens.

FIG. 10 is an aberration diagram illustrating various aberrations in Numerical example 5 in which specific numerical values are applied to the imaging lens illustrated in FIG. 9.

FIG. 11 is a lens cross-sectional view illustrating a sixth configuration example of the imaging lens.

FIG. 12 is an aberration diagram illustrating various aberrations in Numerical example 6 in which specific numerical values are applied to the imaging lens illustrated in FIG. 11.

FIG. 13 is a front view illustrating a configuration example of an imaging unit.

FIG. 14 is a rear view illustrating the configuration example of the imaging unit.

### DETAILED DESCRIPTION

Some embodiments of the present disclosure is described below in detail referring to the drawings. The description is provided in the following order.
1. Basic Configuration of Lenses
2. Functions and Effects
3. Examples of Application to Imaging Unit
4. Numerical Examples of Lenses
5. Other Embodiments

[1. Basic Configuration of Lenses]

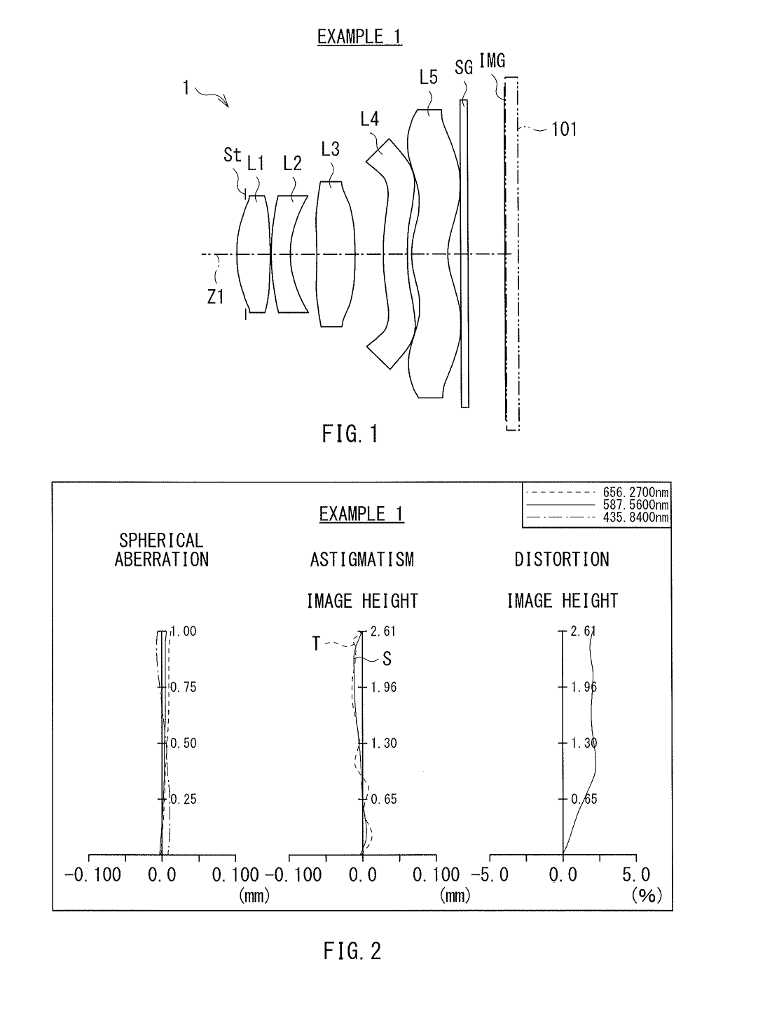

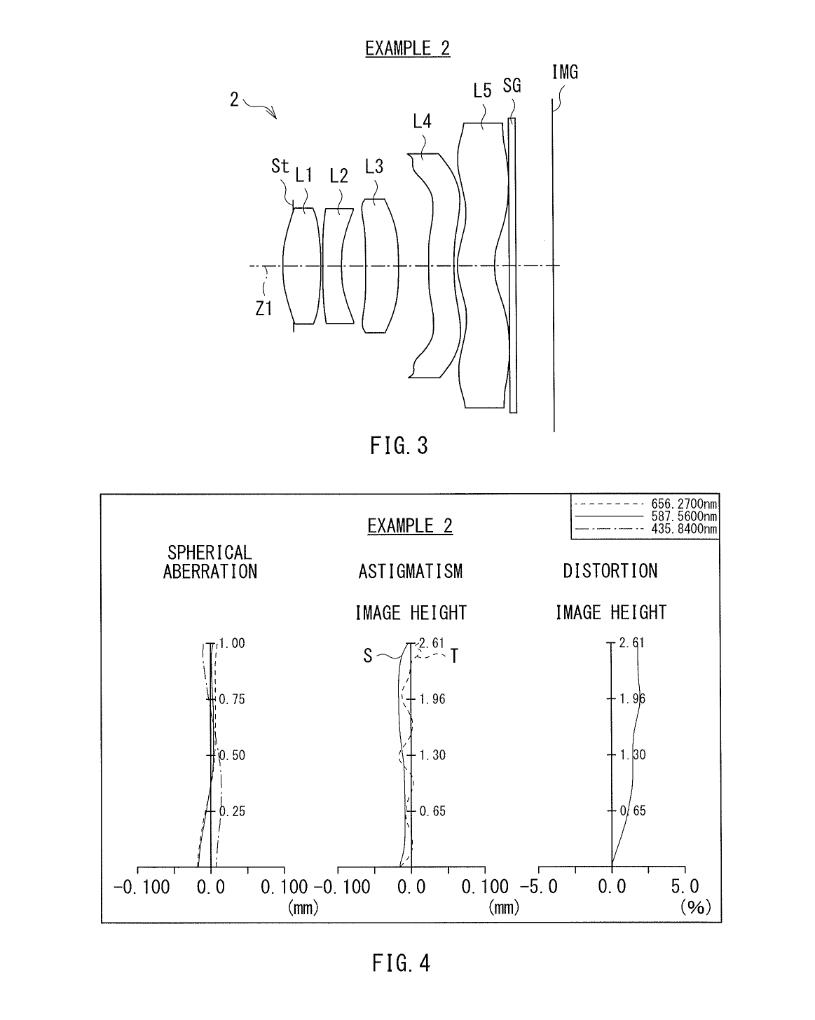

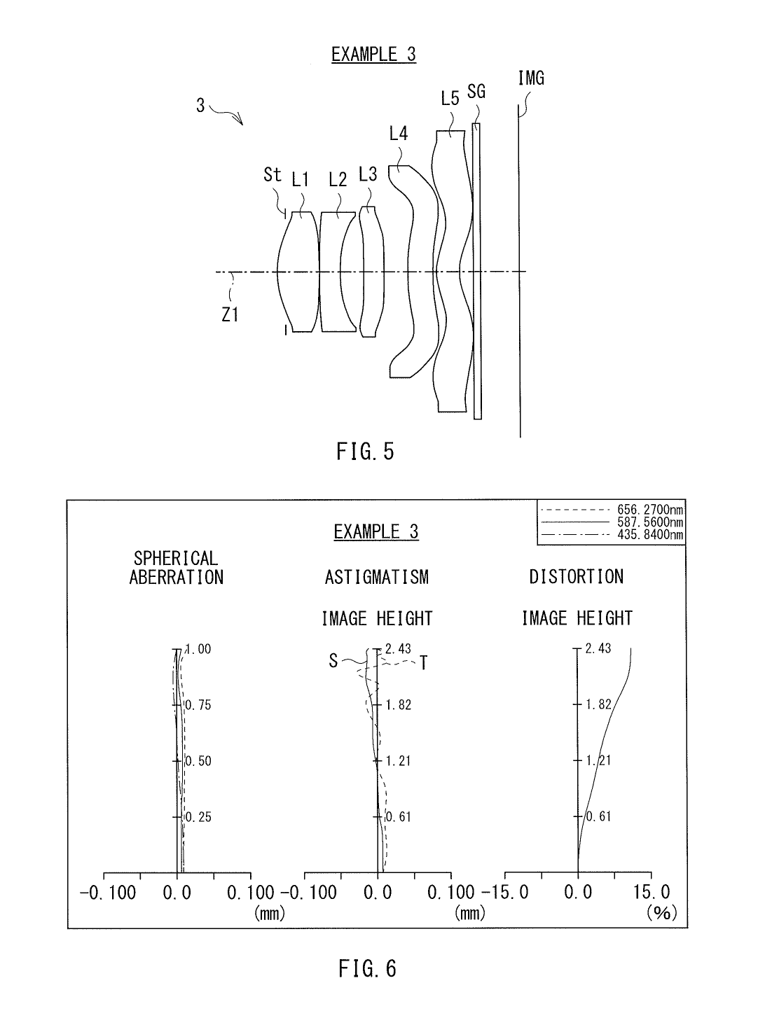

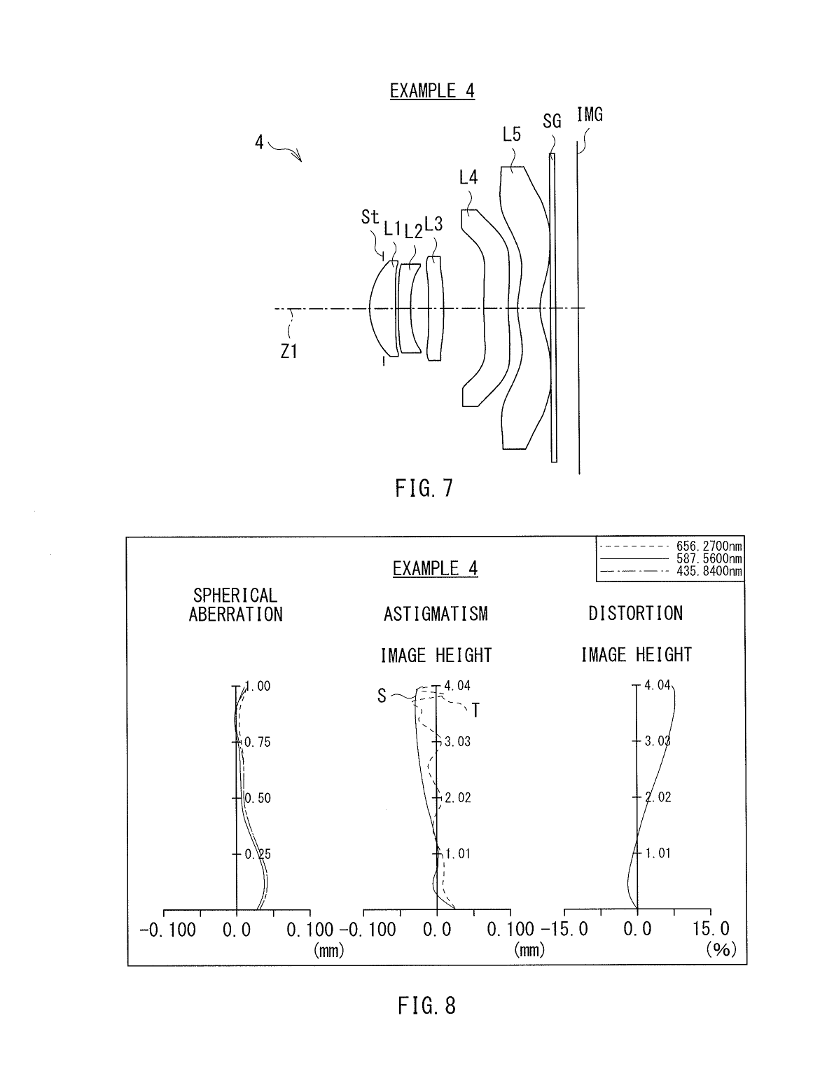

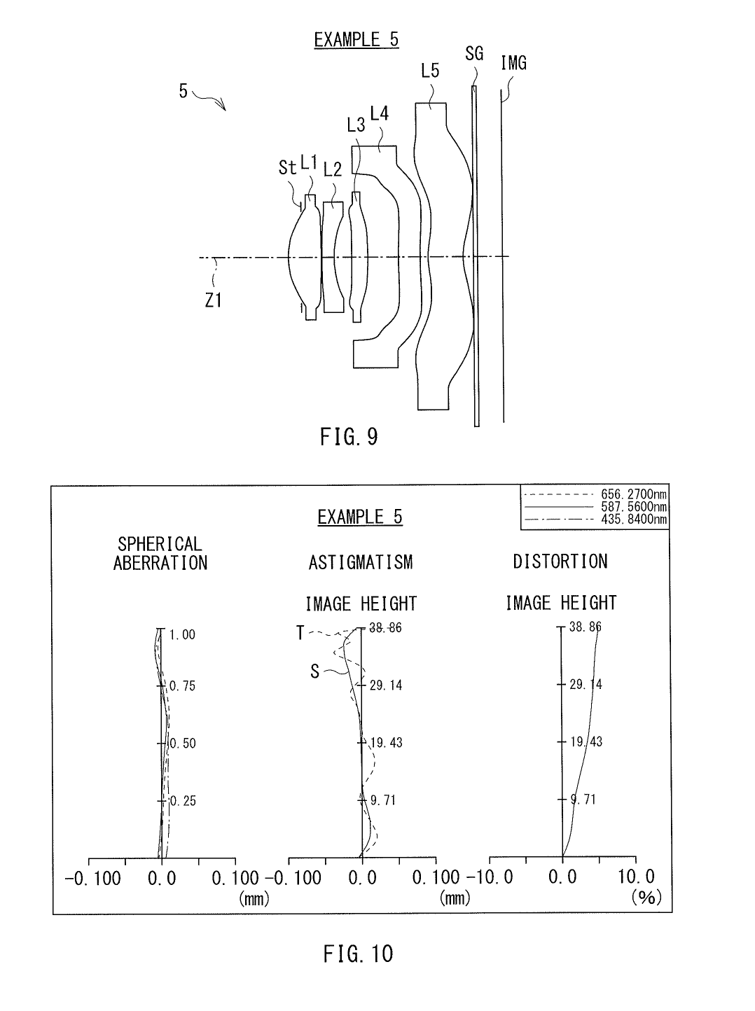

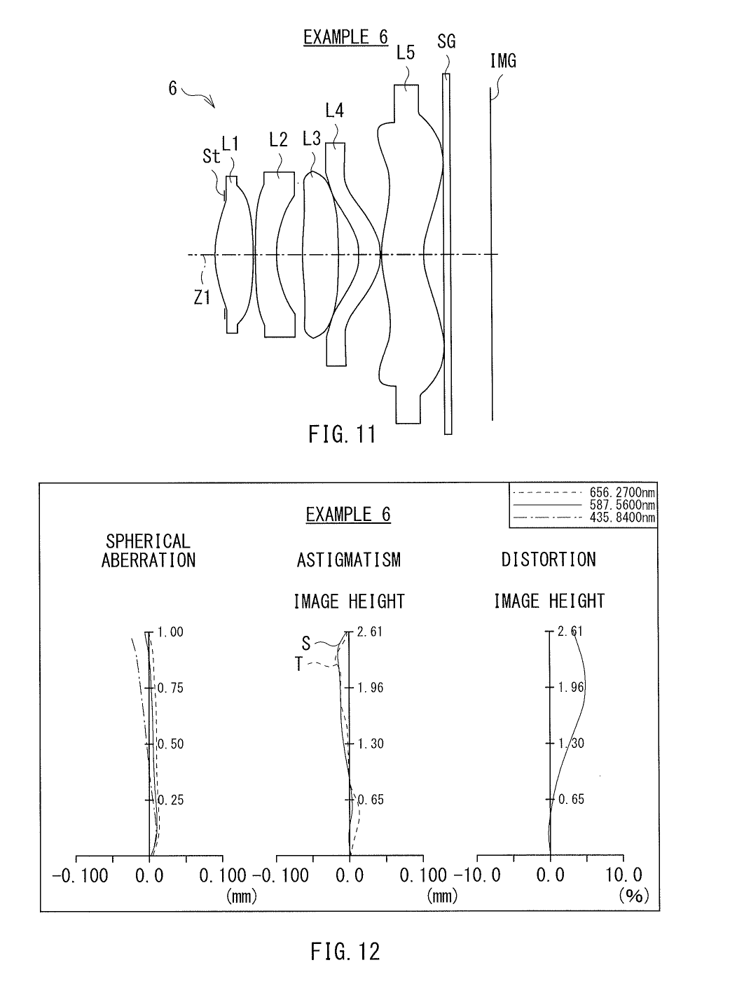

FIG. 1 illustrates a first configuration example of an imaging lens according to an embodiment of the present disclosure. FIG. 3 illustrates a second configuration example of the imaging lens. FIG. 5 illustrates a third configuration example of the imaging lens. FIG. 7 illustrates a fourth configuration example of the imaging lens. FIG. 9 illustrates a fifth configuration example of the imaging lens. FIG. 11 illustrates a sixth configuration example of the imaging lens. Description is provided later of numerical examples in which specific numerical values are applied to the foregoing configuration examples. In FIG. 1, etc., the symbol IMG represents image plane, and the symbol Z1 represents an optical axis. An optical member may be arranged between the imaging lens and the image plane IMG. Examples of the optical member may include a sealing glass SG for protecting the imaging device, and various optical filters.

The configuration of the imaging lens according to the present embodiment is described below appropriately referring to the configuration examples illustrated in FIG. 1, etc. However, the technology of the present disclosure is not limited to the illustrated configuration examples. The imaging lens according to the present embodiment is substantially configured of five lenses, i.e., a first lens L1, a second lens L2, a third lens L3, a fourth lens L4, and a fifth lens L5 that are arranged in order from an object side along the optical axis Z1.

The first lens L1 has positive refractive power. The first lens L1 has an object-sided surface that may be preferably a convex surface.

The second lens L2 has negative refractive power near the optical axis. The second lens L2 has an image-sided surface that may be preferably a concave surface. The second lens L2 may be preferably a negative meniscus lens that has a concave surface facing toward the image side.

The third lens L3 has an object-sided surface that is a convex surface near the optical axis. Also, the third lens L3 has positive refractive power near the optical axis. The third lens L3 may preferably have an aspherical surface that has concave-convex shapes different between a portion near the optical axis and a peripheral portion thereof.

The fourth lens L4 has one of positive refractive power and negative refractive power near the optical axis. The fourth lens L4 may have an aspherical surface that has concave-convex shapes different between a portion near the optical axis and a peripheral portion thereof.

The imaging lens according to the present embodiment satisfies the following Conditional expression (1) related to the fourth lens L4,

v4<40 (1)

where v4 is an Abbe number of the fourth lens L4.

The fifth lens L5 has positive refractive power near the optical axis. The fifth lens L5 has an image-sided surface that may preferably have an aspherical shape that has an inflection point that causes a concave-convex shape to be varied in mid-course in a direction from a central portion to a peripheral portion. The fifth lens L5 may preferably have one or more inflection points other than an intersection with the optical axis Z1. More specifically, the image-sided surface of the fifth lens L5 may be preferably an aspherical surface that has a concave shape near the optical axis and has a convex shape in the peripheral portion.

Other than above, the imaging lens according to the present embodiment may also preferably satisfy predetermined conditional expressions, etc. which are described later.

[2. Functions and Effects]

Next, functions and effects of the imaging lens according to the present embodiment are described. Together therewith, a preferable configuration of the imaging lens according to the present embodiment is described. It is to be noted that the effects described herein are mere examples. The effects of the present disclosure are not limited thereto and may include other effects.

According to the imaging lens according to the present embodiment, each of the lenses is arranged having appropriate refractive power and the shape of each of the lenses is optimized with efficient use of the aspherical surface in the configuration having five lenses as a whole. Moreover, dispersion of each of the lenses is made appropriate by further satisfying Conditional expression (1) described above. This achieves favorable correction of on-axial and magnification chromatic aberrations, which makes it possible to favorably correct various aberrations while achieving compactness.

Conditional expression (1) described above defines the Abbe number of the fourth lens L4. By satisfying Conditional expression (1), on-axial and off-axial chromatic aberrations are favorably corrected. When Conditional expression (1) is not satisfied, a short wavelength in the on-axial chromatic aberration is increased in a minus direction with respect to reference wavelength, which causes insufficiency in correction.

It is to be noted that a numerical range of Conditional expression (1) may be more preferably set as in the following Conditional expression (1)′.

v4<37 (1)′

The imaging lens according to the present embodiment may preferably satisfy one or more of the following Conditional expressions (2) to (6) in addition.

1.0<ΣD/f<1.5 (2)

ΣD is a distance on the optical axis from a vertex of the object-sided surface of the first lens L1 to the image plane, and f is a total focal length of the imaging lens.

Conditional expression (2) described above defines a ratio between the distance along the optical axis Z1 from the most-object-sided surface to the image plane and the total focal length f. When a value of ΣD/f is larger than the upper limit in Conditional expression (2), a dimension of the imaging lens in an optical-axis direction becomes excessively long, which causes difficulty in reduction in size. When the value of ΣD/f is smaller than the lower limit in Conditional expression (2), the total focal length f of the imaging lens becomes excessively large, which prevents achievement of sufficient angle of view. Moreover, it becomes difficult to maintain the performance and to manufacture the imaging lens. Also, it may not be allowed to secure sufficient thickness or sufficient edge thickness of each of the lenses.

It is to be noted that a numerical range of Conditional expression (2) may be more preferably set as in the following Conditional expression (2)′.

1.0<ΣD/f≦1.4 (2)′

−1.0<(r₃₁+r₃₂)/(r₃₁−r₃₂)<1.5 (3)

r₃₁ is a center curvature radius of the object-sided surface of the third lens L3, and r₃₂ is a center curvature radius of an image-sided surface of the third lens L3.

Conditional expression (3) described above defines a relationship between the center curvature radii of the object-sided surface and the image-sided surface of the third lens L3. By satisfying Conditional expression (3), various aberrations are favorably corrected. When a value of (r₃₁+r₃₂)/(r₃₁−r₃₂) is smaller than the lower limit in Conditional expression (3), sensitivity with respect to manufacturing error of the third lens L3 is increased, which is not preferable. When the value of (r₃₁+r₃₂)/(r₃₁−r₃₂) is larger than the upper limit in Conditional expression (3), correction of comma aberration, field curvature, etc. becomes difficult and astigmatic difference is increased, which is not preferable.

It is to be noted that a numerical range of Conditional expression (3) may be more preferably set as in the following Conditional expression (3)′.

−0.7 <(r₃₁+r₃₂)/(r₃₁−r₃₂)<1.2 (3)

−0.625<f/f4<0.1 (4)

f4 is a focal length of the fourth lens.

Conditional expression (4) described above defines distribution of refractive power between the fourth lens L4 and the entire lens system. By satisfying Conditional expression (4), reduction in optical length and favorable correction of aberrations are achieved. When a value of f/f4 is smaller than the lower limit in Conditional expression (4), the refractive power of the fourth lens L4 is reduced. This is not preferable because it becomes difficult to secure telecentricity when the total length of the optical system is made shorter. When the value of f/f4 is larger than the upper limit in Conditional expression (4), the refractive power of the fourth lens L4 is increased. As a result, comma aberration is increased, which makes it difficult to correct aberrations.

It is to be noted that a numerical range of Conditional expression (4) may be more preferably set as in the following Conditional expression (4)′.

−0.57<f/f4<0.03 (4)′

−2.1<f2/f1<−1.2 (5)

f1 is a focal length of the first lens L1, and f2 is a focal length of the second lens L2.

Conditional expression (5) described above defines distribution of refractive power between the first lens L1 and the second lens L2. By satisfying Conditional expression (5), on-axial chromatic aberration and spherical aberration are corrected. When a value of f2/f1 is smaller than the lower limit in Conditional expression (5), the refractive power of the second lens L2 is increased, which causes the on-axial chromatic aberration to be excessively corrected with respect to the reference wavelength. Also, the spherical aberration is excessively corrected in an annular portion. As a result, it becomes difficult to maintain the on-axial chromatic aberration and the spherical aberration to be stable. On the other hand, when the value of f2/f1 is larger than the upper limit in Conditional expression (5), the refractive power of the second lens L2 is reduced, which causes insufficiency in correction of the on-axial chromatic aberration with respect to the reference wavelength. Also, this causes insufficiency in correction of the spherical aberration in the annular portion. Accordingly, it becomes difficult to maintain the on-axial chromatic aberration and the spherical aberration to be stable, which makes it difficult to achieve favorable image formation performance.

It is to be noted that a numerical range of Conditional expression (5) may be more preferably set as in the following Conditional expression (5)′.

−1.9<f2/f1<−1.3 (5)′

0.2<r₅₁/f<0.5 (6)

r₅₁ is a center curvature radius of the object-sided surface of the fifth lens L5.

Conditional expression (6) described above defines distribution of refractive power between the object-sided surface of the fifth lens L5 and the entire lens system. When a value of r₅₁/f is smaller than the lower limit of Conditional expression (6), the center curvature radius of the fifth lens L5 becomes smaller and the refractive power of the fifth lens L5 is increased. Accordingly, it is possible to reduce a maximum exiting angle of an off-axial principal ray but it becomes difficult to correct field curvature, distortion, etc. When the value of r₅₁/f is larger than the upper limit in Conditional expression (6), a paraxial curvature radius of the fifth lens L5 is increased, and an incident angle of rays with respect to the fifth lens L5 is therefore increased. This makes it easier to correct comma aberration, magnification chromatic aberration, etc., but increases the above-described maximum exiting angle of the off-axial principal ray, which makes it easier for shading phenomenon, etc. to be caused.

It is to be noted that a numerical range of Conditional expression (6) may be more preferably set as in the following Conditional expression (6)′.

0.23<r₅₁/f<0.45 (6)′

Moreover, in the imaging lens according to the present embodiment, by causing the most-image-sided lens surface (the image-sided surface of the fifth lens L5) to be the aspherical surface that has a concave shape near the optical axis and has a convex shape in the peripheral portion, an incident angle of light exiting the fifth lens L5 with respect to the image plane IMG is suppressed.

[3. Examples of Application to Imaging Unit]

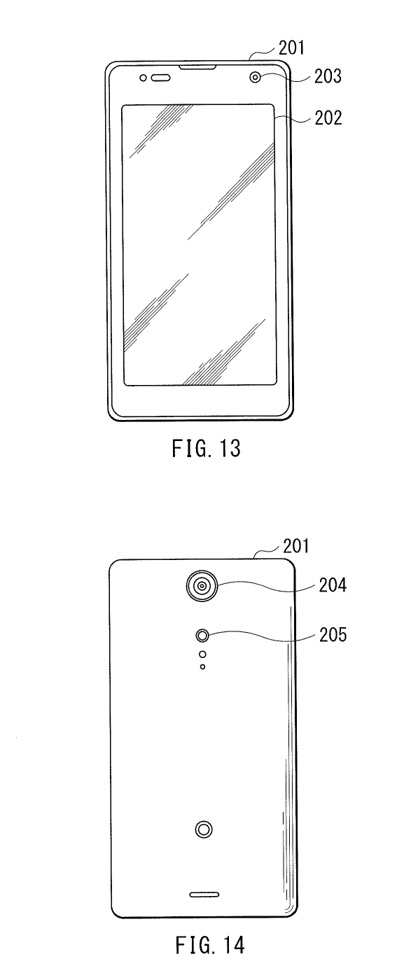

FIGS. 13 and 14 illustrate a configuration example of an imaging unit to which the imaging lens according to the present embodiment is applied. This configuration example is an example of a mobile terminal apparatus (such as a mobile information terminal or a mobile phone terminal) that includes an imaging unit. The mobile terminal apparatus includes an almost-rectangular housing 201. A front surface side (FIG. 13) of the housing 201 is provided with a display section 202, a front camera section 203, etc. A rear surface side (FIG. 14) of the housing 201 is provided with a main camera section 204, a camera flash 205, etc.

The display section 202 may be, for example, a touch panel that allows various operations to be performed by sensing a contact state with respect to a surface thereof. Accordingly, the display section 202 has a function of displaying various pieces of information and an input function that allows various input operations to be performed by a user. The display section 202 displays various pieces of data such as an operation state and images shot by the front camera section 203 or the main camera section 204.

The imaging lens according to the present embodiment may be applicable, for example, as a lens for a camera module of the imaging unit (the front camera section 203 or the main camera section 204) in the mobile terminal apparatus illustrated in FIGS. 13 and 14. When the imaging lens according to the present embodiment is used as such a lens for a camera module, an imaging device 101 such as a CCD (Charge Coupled Devices) or a CMOS (Complementary Metal Oxide Semiconductor) that outputs an imaging signal (an image signal) based on an optical image formed by the imaging lens is arranged around the image plane IMG of the imaging lens as illustrated in FIG. 1. In this case, as illustrated in FIG. 1, etc., an optical member such as a sealing glass SG for protecting the imaging device, and various optical filters may be arranged between the fifth lens L5 and the image plane IMG.

It is to be noted that the imaging lens according to the present embodiment is not limitedly applied to the above-described mobile terminal apparatus, and is applicable as an imaging lens for other electronic apparatus such as a digital still camera or a digital video camcorder. In addition thereto, the imaging lens according to the present embodiment is applicable to general compact imaging units that use the solid-state imaging device such as a CCD or a CMOS. Examples of such general compact imaging units may include an optical sensor, a portable module camera, and a web camera.

### EXAMPLES

### 4. Numerical Examples of Lenses

Next, specific numerical examples of the imaging lens according to the present embodiment are described. The description is provided of numerical examples in which specific numerical values are applied to the imaging lenses 1, 2, 3, 4, 5, and 6 of the respective configuration examples illustrated in FIGS. 1, 3, 5, 7, 9, and 11.

It is to be noted that symbols etc. in tables and the description below represent the following. “Si” represents the number of an i-th surface counted from the most object side. “Ri” represents a value (mm) of a paraxial curvature radius of the i-th surface. “Di” represents a value (mm) of a spacing on the optical axis between the i-th surface and the (i+1)th surface. “Ndi” represents a value of a refractive index of the d-line (having a wavelength of 587.6 nm) of a material of an optical component that has the i-th surface. “vdi” represents a value of an Abbe number of the d-line of the material of the optical component that has the i-th surface. “∞” in the value of “Ri” indicates that the relevant surface is a planar surface, a virtual surface, or a stop surface (an aperture stop). “STO” in “Si” indicates that the relevant surface is the aperture stop. “f” represents a total focal length of the lens system. “Fno” represents an F number. “ω” represents a half angle of view.

Some of the lenses used in the respective numerical examples have a lens surface that is formed to be an aspherical surface. “ASP” in “Si” indicates that the relevant surface is an aspherical surface. The aspherical shape is defined by the following expression. It is to be noted that “E-i” represents an exponential expression having 10 as a base, i.e., “10⁻ⁱ” in the respective tables that show aspherical surface coefficients described later. To give an example, “0.12345E-05” represents “0.12345×10⁻⁵”.

Z=C·h²/{1+(1−K·C²·h²)^{1/2}}+ΣAn·hⁿ (A)

n is an integer of 3 or larger, Z is a depth of the aspherical surface, C is a paraxial curvature which is represented by 1/R, h is a distance from the optical axis to the lens surface, K is eccentricity (a 2nd-order aspherical surface coefficient), and An is an n-th-order aspherical surface coefficient.

### Configuration Common to Respective Numerical Examples

Each of the imaging lenses 1, 2, 3, 4, 5, and 6 to which the respective numerical examples below are applied has a configuration that satisfies the above-described basic configuration of the lens. Each of the imaging lenses 1, 2, 3, 4, 5, and 6 is substantially configured of five lenses, i.e., the first lens L1, the second lens L2, the third lens L3, the fourth lens L4, and the fifth lens L5 that are arranged in order from the object side. The image-sided surface of the fifth lens L5 is an aspherical surface that has a concave shape near the optical axis and has a convex shape in the peripheral portion. The sealing glass SG is arranged between the fifth lens L5 and the image plane IMG. An aperture stop St is arranged near the front side of the first lens L1.

### Numerical Example 1

In the imaging lens 1 illustrated in FIG. 1, the first lens L1 has positive refractive power, and has an object-sided surface that is a convex surface. The second lens L2 has negative refractive power near the optical axis, and has an image-sided surface that is a concave surface. The third lens L3 has an object-sided surface that is a convex surface near the optical axis. Also, the third lens L3 has positive refractive power near the optical axis. The fourth lens L4 has negative refractive power near the optical axis. The fifth lens L5 has positive refractive power near the optical axis.

Lens data of Numerical example 1 in which specific numerical values are applied to the imaging lens 1 is shown in Table 1 together with values of the total focal length f of the lens system, the F-number, and the half angle of view w. In the imaging lens 1, both surfaces of each of the first lens L1 to the fifth lens L5 are formed to be aspherical surfaces. Values of aspherical surface coefficients A3 to A20 in those aspherical surfaces are shown in Table 2 together with the values of the coefficient K.

TABLE 1
f = 3.35 mm
Fno = 1.98
ω = 37.32°
Example 1

| Lens | Si | Ri | Di | Ndi | νdi |
|---|---|---|---|---|---|
| (Virtual | 1 | ∞ | 0.140 | | |
| surface) | | | | | |
| (St) | 2(STO) | ∞ | −0.140 | | |
| L1 | 3(ASP) | 1.778 | 0.538 | 1.534 | 55.66 |
| | 4(ASP) | −4.773 | 0.022 | | |
| L2 | 5(ASP) | 3.5631 | 0.300 | 1.634 | 23.87 |
| | 6(ASP) | 1.3621 | 0.416 | | |
| L3 | 7(ASP) | 122.1443 | 0.617 | 1.534 | 55.66 |
| | 8(ASP) | −5.5134 | 0.454 | | |
| L4 | 9(ASP) | 10.5693 | 0.375 | 1.634 | 23.87 |
| | 10(ASP) | 3.1153 | 0.070 | | |
| L5 | 11(ASP) | 0.9520 | 0.586 | 1.534 | 55.66 |
| | 12(ASP) | 0.9993 | 0.212 | | |
| (SG) | 13 | ∞ | 0.110 | 1.512 | 56.90 |
| | 14 | ∞ | 0.590 | | |
| (IMG) | 15 | ∞ | | | |

TABLE 2
Example 1

| | S3 | S4 | S5 | S6 | S7 |
|---|---|---|---|---|---|
| K | −1.9359 | −8.3979 | −10.0000 | 0.4013 | 10.0000 |
| A3 | 0 | 0 | 0 | 0 | 0 |
| A4 | 0.02712 | 0.09574 | −0.03407 | −0.24590 | −0.04453 |
| A5 | 0 | 0 | 0 | 0 | 0 |
| A6 | −0.01272 | −0.12981 | 0.22745 | 0.41526 | −0.37018 |
| A7 | 0 | 0 | 0 | 0 | 0 |
| A8 | −0.03741 | 0.00915 | −0.59207 | −0.76796 | 2.17130 |
| A9 | 0 | 0 | 0 | 0 | 0 |
| A10 | 0.03909 | −0.02007 | 0.87901 | 1.10089 | −7.52540 |
| A11 | 0 | 0 | 0 | 0 | 0 |
| A12 | −0.0552 | 0.0484 | −0.8705 | −1.2676 | 16.7857 |
| A13 | 0 | 0 | 0 | 0 | 0 |
| A14 | 0 | −0.03945 | 0.58543 | 1.04489 | −23.76890 |
| A15 | 0 | 0 | 0 | 0 | 0 |
| A16 | 0 | 0 | −0.19385 | −0.41596 | 20.67746 |
| A17 | 0 | 0 | 0 | 0 | 0 |
| A18 | 0 | 0 | 0 | 0 | −9.943755 |
| A19 | 0 | 0 | 0 | 0 | 0 |
| A20 | 0 | 0 | 0 | 0 | 2.00311 |
| | S8 | S9 | S10 | S11 | S12 |
| K | −9.0445 | −8.9344 | 1.9281 | −6.5111 | −5.4395 |
| A3 | 0 | −0.00461 | 0.00083 | −0.01342 | 0.01051 |
| A4 | −0.02563 | 0.50129 | −0.03814 | −0.12411 | −0.02699 |
| A5 | 0 | −0.000164 | −0.0006397 | 0.0006472 | −2.57E−05 |
| A6 | −0.39499 | −1.64790 | 0.13284 | −0.21284 | −0.26293 |
| A7 | 0 | −0.00097 | 0.00021 | −1.60E−05 | 3.77E−05 |
| A8 | 1.01229 | 4.11139 | −0.34934 | 0.30424 | 0.38269 |
| A9 | 0 | −2.02E−05 | 5.37E−05 | −8.50E−07 | −3.85E−06 |
| A10 | −1.85248 | −7.92607 | 0.34465 | −0.18647 | −0.31868 |
| A11 | 0 | 5.91E−05 | 2.94E−05 | −2.49E−07 | 3.86E−07 |
| A12 | 2.6010 | 10.7720 | −0.1986 | 0.0720 | 0.1731 |
| A13 | 0 | 8.19E−05 | −1.93E−06 | −5.92E−08 | 1.64E−07 |
| A14 | −2.69229 | −10.18654 | 0.07201 | −0.01920 | −0.06210 |
| A15 | 0 | −8.83E−05 | −2.90E−06 | 1.43E−09 | 4.24E−08 |
| A16 | 1.91642 | 6.63068 | −0.01729 | 0.00360 | 0.01467 |
| A17 | 0 | 1.66E−05 | −3.47E−07 | −4.56E−09 | 1.05E−08 |
| A18 | −0.816067 | −2.901785 | 0.003246 | −0.000466 | −0.002250 |
| A19 | 0 | −2.71E−05 | −1.06E−07 | −3.03E−10 | 1.62E−09 |
| A20 | 0.15606 | 0.81149 | −0.00061 | 3.94E−05 | 0.00021 |

Various aberrations in Numerical example 1 above are shown in FIG. 2. FIG. 2 shows spherical aberration, astigmatism (field curvature), and distortion as the various aberrations. Each of aberration diagrams thereof shows aberration using the d-line (587.56 nm) as the reference wavelength. The spherical aberration diagram also shows aberrations with respect to g-line (435.84 nm) and C-line (656.27 nm). In the aberration diagram of the astigmatism, “S” represents a value of aberration in a sagittal image plane, and “T” represents a value of aberration in a tangential image plane. This is similarly applicable to aberration diagrams below of other numerical examples.

As can be clearly seen from the respective aberration diagrams above, various aberrations are favorably corrected while compactness is achieved, and superior optical performance is achieved accordingly.

### Numerical Example 2

In the imaging lens 2 illustrated in FIG. 3, the first lens L1 has positive refractive power, and has an object-sided surface that is a convex surface. The second lens L2 has negative refractive power near the optical axis, and has an image-sided surface that is a concave surface. The third lens L3 has an object-sided surface that is a convex surface near the optical axis. Also, the third lens L3 has positive refractive power near the optical axis. The fourth lens L4 has negative refractive power near the optical axis. The fifth lens L5 has positive refractive power near the optical axis.

Lens data of Numerical example 2 in which specific numerical values are applied to the imaging lens 2 is shown in Table 3 together with values of the total focal length f of the lens system, the F-number, and the half angle of view ω. In the imaging lens 2, both surfaces of each of the first lens L1 to the fifth lens L5 are formed to be aspherical surfaces. Values of aspherical surface coefficients A3 to A20 in those aspherical surfaces are shown in Table 4 together with the values of the coefficient K.

TABLE 3
f = 3.35 mm
Fno = 1.94
ω = 37.32°
Example 1

| Lens | Si | Ri | Di | Ndi | νdi |
|---|---|---|---|---|---|
| (Virtual | 1 | ∞ | 0.170 | | |
| surface) | | | | | |
| (St) | 2(STO) | ∞ | −0.170 | | |
| L1 | 3(ASP) | 1.8950 | 0.615 | 1.534 | 55.66 |
| | 4(ASP) | −3.2205 | 0.022 | | |
| L2 | 5(ASP) | 8.3248 | 0.300 | 1.634 | 23.87 |
| | 6(ASP) | 1.6232 | 0.391 | | |
| L3 | 7(ASP) | 998.6501 | 0.534 | 1.534 | 55.66 |
| | 8(ASP) | −5.8355 | 0.486 | | |
| L4 | 9(ASP) | 9.9377 | 0.407 | 1.634 | 23.87 |
| | 10(ASP) | 3.2612 | 0.058 | | |
| L5 | 11(ASP) | 0.9000 | 0.588 | 1.534 | 55.66 |
| | 12(ASP) | 0.9072 | 0.250 | | |
| (SG) | 13 | ∞ | 0.110 | 1.512 | 56.90 |
| | 14 | ∞ | 0.598 | | |
| (IMG) | 15 | ∞ | | | |

TABLE 4
Example 2

| | S3 | S4 | S5 | S6 | S7 |
|---|---|---|---|---|---|
| K | −2.2040 | −9.9999 | 10.0000 | 0.4947 | 10.0000 |
| A3 | 0 | 0 | 0 | 0 | 0 |
| A4 | 0.01037 | 0.11414 | −0.02515 | −0.24725 | −0.09742 |
| A5 | 0 | 0 | 0 | 0 | 0 |
| A6 | 0.00309 | −0.19199 | 0.24811 | 0.49138 | −0.37998 |
| A7 | 0 | 0 | 0 | 0 | 0 |
| A8 | −0.07864 | 0.05872 | −0.61607 | −0.85326 | 2.11745 |
| A9 | 0 | 0 | 0 | 0 | 0 |
| A10 | 0.06621 | −0.06159 | 0.64654 | 1.05190 | −6.91143 |
| A11 | 0 | 0 | 0 | 0 | 0 |
| A12 | −0.05305 | 0.09800 | −0.25042 | −0.94197 | 15.05602 |
| A13 | 0 | 0 | 0 | 0 | 0 |
| A14 | 0 | −0.05739 | −0.02707 | 0.62293 | −21.37208 |
| A15 | 0 | 0 | 0 | 0 | 0 |
| A16 | 0 | 0 | 0.02672 | −0.20516 | 19.05841 |
| A17 | 0 | 0 | 0 | 0 | 0 |
| A18 | 0 | 0 | 0 | 0 | −9.48058 |
| A19 | 0 | 0 | 0 | 0 | 0 |
| A20 | 0 | 0 | 0 | 0 | 1.97197 |
| | S8 | S9 | S10 | S11 | S12 |
| K | −1.6414 | 10.0000 | 2.1879 | −4.6663 | −1.4851 |
| A3 | 0 | −0.00662 | 0.00112 | 0.01149 | 0.02204 |
| A4 | −0.05501 | 0.48365 | −0.06758 | −0.37004 | −0.55238 |
| A5 | 0 | −0.009824 | −0.003282 | −0.0028108 | −1.16E−03 |
| A6 | −0.44367 | −1.34303 | 0.19698 | 0.24572 | 0.51086 |
| A7 | 0 | −0.00262 | −0.00323 | −7.82E−05 | 8.85E−04 |
| A8 | 1.18247 | 2.41164 | −0.43402 | −0.14085 | −0.38224 |
| A9 | 0 | 1.06E−03 | 5.05E−04 | 3.30E−05 | −9.83E−05 |
| A10 | −2.24354 | −3.12663 | 0.41341 | 0.07694 | 0.21037 |
| A11 | 0 | −2.77E−04 | 1.35E−04 | 5.06E−06 | −1.97E−05 |
| A12 | 3.49305 | 2.66237 | −0.23867 | −0.02960 | −0.07829 |
| A13 | 0 | −1.95E−04 | 1.26E−05 | 1.02E−06 | −5.07E−07 |
| A14 | −4.13801 | −1.43317 | 0.09225 | 0.00711 | 0.01884 |
| A15 | 0 | 6.15E−06 | −1.45E−05 | 8.07E−08 | 1.14E−07 |
| A16 | 3.34412 | 0.46569 | −0.02372 | −0.00102 | −0.00280 |
| A17 | 0 | 2.47E−05 | −2.61E−06 | 3.47E−08 | 1.96E−08 |
| A18 | −1.56943 | −0.08262 | 0.00367 | 7.96E−05 | 0.00023 |
| A19 | 0 | 1.03E−06 | 8.77E−07 | −1.45E−08 | 6.58E−09 |
| A20 | 0.32124 | 0.00610 | −0.00026 | −2.61E−06 | −8.37E−06 |

Various aberrations in Numerical example 2 above are shown in FIG. 4. As can be clearly seen from the respective aberration diagrams, various aberrations are favorably corrected while compactness is achieved, and superior optical performance is achieved accordingly.

### Numerical Example 3

In the imaging lens 3 illustrated in FIG. 5, the first lens L1 has positive refractive power, and has an object-sided surface that is a convex surface. The second lens L2 has negative refractive power near the optical axis, and has an image-sided surface that is a concave surface. The third lens L3 has an object-sided surface that is a convex surface near the optical axis. Also, the third lens L3 has positive refractive power near the optical axis. The fourth lens L4 has negative refractive power near the optical axis. The fifth lens L5 has positive refractive power near the optical axis.

Lens data of Numerical example 3 in which specific numerical values are applied to the imaging lens 3 is shown in Table 5 together with values of the total focal length f of the lens system, the F-number, and the half angle of view ω. In the imaging lens 3, both surfaces of each of the first lens L1 to the fifth lens L5 are formed to be aspherical surfaces. Values of aspherical surface coefficients A3 to A20 in those aspherical surfaces are shown in Table 6 together with the values of the coefficient K.

TABLE 5
f = 3.15 mm
Fno = 1.91
ω = 37.58°
Example 3

| Lens | Si | Ri | Di | Ndi | νdi |
|---|---|---|---|---|---|
| (Virtual | 1 | ∞ | 0.131 | | |
| surface) | | | | | |
| (St) | 2(STO) | ∞ | −0.131 | | |
| L1 | 3(ASP) | 1.5097 | 0.681 | 1.534 | 55.66 |
| | 4(ASP) | −5.0027 | 0.000 | | |
| L2 | 5(ASP) | 16.7480 | 0.328 | 1.634 | 23.87 |
| | 6(ASP) | 1.9666 | 0.384 | | |
| L3 | 7(ASP) | 57.2702 | 0.327 | 1.534 | 55.66 |
| | 8(ASP) | −56.3621 | 0.384 | | |
| L4 | 9(ASP) | 5.4235 | 0.400 | 1.634 | 23.87 |
| | 10(ASP) | 3.1301 | 0.057 | | |
| L5 | 11(ASP) | 0.7421 | 0.369 | 1.534 | 55.66 |
| | 12(ASP) | 0.7724 | 0.230 | | |
| (SG) | 13 | ∞ | 0.110 | 1.512 | 56.90 |
| | 14 | ∞ | 0.630 | | |
| (IMG) | 15 | ∞ | | | |

TABLE 6
Example 3

| | S3 | S4 | S5 | S6 | S7 |
|---|---|---|---|---|---|
| K | −1.41865 | 5.51547 | −95.67382 | 3.18005 | −5.59314 |
| A3 | 0 | 0 | 0 | 0 | 0 |
| A4 | 0.02871 | 0.07227 | 0.01571 | −0.12840 | −0.18600 |
| A5 | 0 | 0 | 0 | 0 | 0 |
| A6 | 0.02281 | 0.10742 | 0.23861 | 0.27266 | −0.18214 |
| A7 | 0 | 0 | 0 | 0 | 0 |
| A8 | −0.13396 | −1.20657 | −1.02048 | −0.59350 | 0.95971 |
| A9 | 0 | 0 | 0 | 0 | 0 |
| A10 | 0.16920 | 2.27093 | 1.42956 | 1.24930 | −1.54126 |
| A11 | 0 | 0 | 0 | 0 | 0 |
| A12 | −0.14403 | −1.92284 | −0.51881 | −2.54115 | 0.62244 |
| A13 | 0 | 0 | 0 | 0 | 0 |
| A14 | 0 | 0.61451 | −0.38820 | 3.26340 | 1.01640 |
| A15 | 0 | 0 | 0 | 0 | 0 |
| A16 | 0 | 0 | 0.27502 | −1.70285 | −0.73109 |
| A17 | 0 | 0 | 0 | 0 | 0 |
| A18 | 0 | 0 | 0 | 0 | 0 |
| A19 | 0 | 0 | 0 | 0 | 0 |
| A20 | 0 | 0 | 0 | 0 | 0 |
| | S8 | S9 | S10 | S11 | S12 |
| K | −40.12277 | −79.91938 | 2.41232 | −3.28684 | −2.05966 |
| A3 | 0 | 0 | 0 | 0 | 0 |
| A4 | −0.15469 | 0.56443 | −0.07852 | −0.48705 | −0.50294 |
| A5 | 0 | 0 | 0 | 0 | 0 |
| A6 | −0.52821 | −1.89696 | 0.17299 | 0.36242 | 0.44483 |
| A7 | 0 | 0 | 0 | 0 | 0 |
| A8 | 1.55395 | 4.10399 | −0.34964 | −0.35285 | −0.32467 |
| A9 | 0 | 0 | 0 | 0 | 0 |
| A10 | −2.24341 | −6.39724 | 0.18705 | 0.30755 | 0.17288 |
| A11 | 0 | 0 | 0 | 0 | 0 |
| A12 | 1.80900 | 6.54833 | 0.06034 | −0.16262 | −0.05856 |
| A13 | 0 | 0 | 0 | 0 | 0 |
| A14 | −0.69954 | −4.21248 | −0.12106 | 0.05112 | 0.01189 |
| A15 | 0 | 0 | 0 | 0 | 0 |
| A16 | 0.12368 | 1.59826 | 0.05892 | −0.00950 | −0.00135 |
| A17 | 0 | 0 | 0 | 0 | 0 |
| A18 | 0 | −0.31770 | −0.01257 | 9.72E−04 | 7.37E−05 |
| A19 | 0 | 0 | 0 | 0 | 0 |
| A20 | 0 | 0.02462 | 0.00100 | −4.23E−05 | −1.18E−06 |

Various aberrations in Numerical example 3 above are shown in FIG. 6. As can be clearly seen from the respective aberration diagrams, various aberrations are favorably corrected while compactness is achieved, and superior optical performance is achieved accordingly.

### Numerical Example 4

In the imaging lens 4 illustrated in FIG. 7, the first lens L1 has positive refractive power, and has an object-sided surface that is a convex surface. The second lens L2 has negative refractive power near the optical axis, and has an image-sided surface that is a concave surface. The third lens L3 has an object-sided surface that is a convex surface near the optical axis. Also, the third lens L3 has positive refractive power near the optical axis. The fourth lens L4 has negative refractive power near the optical axis. The fifth lens L5 has positive refractive power near the optical axis.

Lens data of Numerical example 4 in which specific numerical values are applied to the imaging lens 4 is shown in Table 7 together with values of the total focal length f of the lens system, the F-number, and the half angle of view ω. In the imaging lens 4, both surfaces of each of the first lens L1 to the fifth lens L5 are formed to be aspherical surfaces. Values of aspherical surface coefficients A3 to A20 in those aspherical surfaces are shown in Table 8 together with the value of the coefficient K.

TABLE 7
f = 4.77 mm
Fno = 2.07
ω = 38.40°
Example 4

| Lens | Si | Ri | Di | Ndi | νdi |
|---|---|---|---|---|---|
| (Virtual | 1 | ∞ | 0.334 | | |
| surface) | | | | | |
| (St) | 2(STO) | ∞ | −0.334 | | |
| L1 | 3(ASP) | 1.6378 | 0.641 | 1.534 | 55.66 |
| | 4(ASP) | 28.9290 | 0.071 | | |
| L2 | 5(ASP) | 12.3017 | 0.300 | 1.642 | 22.46 |
| | 6(ASP) | 2.9050 | 0.457 | | |
| L3 | 7(ASP) | 177.6139 | 0.376 | 1.534 | 55.66 |
| | 8(ASP) | −13.4459 | 1.008 | | |
| L4 | 9(ASP) | 9.4549 | 0.611 | 1.642 | 22.46 |
| | 10(ASP) | 3.3469 | 0.233 | | |
| L5 | 11(ASP) | 1.3231 | 0.566 | 1.534 | 55.66 |
| | 12(ASP) | 1.2026 | 0.278 | | |
| (SG) | 13 | ∞ | 0.110 | 1.5120 | 56.90 |
| | 14 | ∞ | 0.584 | | |
| (IMG) | 15 | ∞ | | | |

TABLE 8
Example 4

| | S3 | S4 | S5 | S6 | S7 |
|---|---|---|---|---|---|
| K | −0.80951 | 20.00000 | −20.00000 | 5.71268 | −10.00020 |
| A3 | 0 | 0 | 0.00242 | 0.00223 | −0.03253 |
| A4 | 0.02438 | −0.01261 | −0.05709 | −0.05453 | 0.01092 |
| A5 | 0 | 0 | 0.05980 | 0.01898 | −0.04804 |
| A6 | 0.01386 | 0.04794 | 0.03858 | 0.06236 | −0.10413 |
| A7 | 0 | 0 | −0.02565 | −0.01868 | 0.02317 |
| A8 | −0.01305 | −0.03262 | −0.00339 | −0.02910 | 0.27885 |
| A9 | 0 | 0 | 0.00854 | −0.01041 | 0.01040 |
| A10 | 0.01721 | 0.01772 | −0.01188 | 0.01140 | −0.40762 |
| A11 | 0 | 0 | 0.01484 | 0.06679 | −0.01629 |
| A12 | −0.00901 | −0.00570 | −0.00939 | −0.04871 | 0.35260 |
| A13 | 0 | 0 | 0 | 0 | 0.00681 |
| A14 | 0.00247 | 0 | 0 | 0 | −0.14985 |
| A15 | 0 | 0 | 0 | 0 | 0.00862 |
| A16 | 0 | 0 | 0 | 0 | 0.01670 |
| A17 | 0 | 0 | 0 | 0 | 0 |
| A18 | 0 | 0 | 0 | 0 | 0 |
| A19 | 0 | 0 | 0 | 0 | 0 |
| A20 | 0 | 0 | 0 | 0 | 0 |
| | S8 | S9 | S10 | S11 | S12 |
| K | 20.00000 | 10.60184 | 0.87270 | −11.30401 | −8.28376 |
| A3 | 0.00237 | −0.01429 | −0.16317 | 0.01311 | 0.05617 |
| A4 | −0.08712 | 0.01544 | 0.04199 | −0.16978 | −0.09964 |
| A5 | 0.05244 | −0.00060 | −0.04580 | 0.00797 | −6.78E−03 |
| A6 | 0.02608 | −0.07959 | 0.11282 | 0.08737 | 0.02836 |
| A7 | −0.02234 | −0.00026 | −0.00050 | 1.21E−04 | 1.99E−03 |
| A8 | −0.15134 | 0.13377 | −0.09831 | −0.04415 | −0.00741 |
| A9 | 0.01580 | 2.92E−05 | −4.43E−05 | 1.66E−05 | −1.62E−04 |
| A10 | 0.33843 | −0.16403 | 0.04208 | 0.01477 | 0.00145 |
| A11 | −0.00176 | 8.13E−06 | −8.80E−05 | −2.71E−07 | −1.32E−06 |
| A12 | −0.38547 | 0.11867 | −0.00253 | −0.00309 | −0.00020 |
| A13 | −0.00020 | 2.48E−07 | −2.44E−05 | 1.87E−08 | 7.69E−07 |
| A14 | 0.24585 | −0.05113 | −0.00734 | 0.00040 | 1.89E−05 |
| A15 | 0.00315 | 1.73E−07 | 4.10E−07 | −2.13E−08 | 1.62E−08 |
| A16 | −0.08581 | 0.01278 | 0.00470 | −3.24E−05 | −1.17E−06 |
| A17 | 0.00380 | 3.27E−08 | 5.49E−07 | −1.70E−10 | −2.21E−09 |
| A18 | 0.00912 | −0.00169 | −0.00158 | 1.45E−06 | 4.40E−08 |
| A19 | 0 | −3.28E−09 | −1.95E−09 | 3.60E−10 | −2.04E−10 |
| A20 | 0 | 9.15E−05 | 3.31E−04 | −2.81E−08 | −7.34E−10 |

Various aberrations in Numerical example 4 above are shown in FIG. 8. As can be clearly seen from the respective aberration diagrams, various aberrations are favorably corrected while compactness is achieved, and superior optical performance is achieved accordingly.

### Numerical Example 5

In the imaging lens 5 illustrated in FIG. 9, the first lens L1 has positive refractive power, and has an object-sided surface that is a convex surface. The second lens L2 has negative refractive power near the optical axis, and has an image-sided surface that is a concave surface. The third lens L3 has an object-sided surface that is a convex surface near the optical axis. Also, the third lens L3 has positive refractive power near the optical axis. The fourth lens L4 has negative refractive power near the optical axis. The fifth lens L5 has positive refractive power near the optical axis.

Lens data of Numerical example 5 in which specific numerical values are applied to the imaging lens 5 is shown in Table 9 together with values of the total focal length f of the lens system, the F-number, and the half angle of view ω. In the imaging lens 5, both surfaces of each of the first lens L1 to the fifth lens L5 are formed to be aspherical surfaces. Values of aspherical surface coefficients A3 to A20 in those aspherical surfaces are shown in Table 10 together with the values of the coefficient K.

TABLE 9
f = 4.77 mm
Fno = 2.07
ω = 38.86°
Example 4

| Lens | Si | Ri | Di | Ndi | νdi |
|---|---|---|---|---|---|
| (Virtual | 1 | ∞ | 0.332 | | |
| surface) | | | | | |
| (St) | 2(STO) | ∞ | −0.332 | | |
| L1 | 3(ASP) | 1.8478 | 0.850 | 1.534 | 55.66 |
| | 4(ASP) | −13.6656 | 0.028 | | |
| L2 | 5(ASP) | 23.5393 | 0.320 | 1.642 | 22.46 |
| | 6(ASP) | 2.6457 | 0.459 | | |
| L3 | 7(ASP) | 49.9303 | 0.417 | 1.549 | 44.14 |
| | 8(ASP) | −12.0941 | 0.807 | | |
| L4 | 9(ASP) | 12.9149 | 0.574 | 1.634 | 22.87 |
| | 10(ASP) | 5.7454 | 0.210 | | |
| L5 | 11(ASP) | 2.1213 | 0.914 | 1.534 | 55.66 |
| | 12(ASP) | 1.8135 | 0.262 | | |
| (SG) | 13 | ∞ | 0.110 | 1.5120 | 56.90 |
| | 14 | ∞ | 0.655 | | |
| (IMG) | 15 | ∞ | | | |

TABLE 10
Example 5

| | S3 | S4 | S5 | S6 | S7 |
|---|---|---|---|---|---|
| K | −1.55045 | 3.576218 | −10 | 2.938104 | −10 |
| A3 | 0 | 0 | 0 | 0 | 0 |
| A4 | 0.026689 | 0.018144 | −0.0134 | −0.05228 | −0.05583 |
| A5 | 0 | 0 | 0 | 0 | 0 |
| A6 | 0.018978 | 0.084473 | 0.134503 | 0.113317 | −0.04871 |
| A7 | 0 | 0 | 0 | 0 | 0 |
| A8 | −0.05179 | −0.23937 | −0.28419 | −0.22573 | 0.180927 |
| A9 | 0 | 0 | 0 | 0 | 0 |
| A10 | 0.085035 | 0.349791 | 0.398121 | 0.371075 | −0.36462 |
| A11 | 0 | 0 | 0 | 0 | 0 |
| A12 | −0.08033 | −0.33541 | −0.38349 | −0.39163 | 0.45319 |
| A13 | 0 | 0 | 0 | 0 | 0 |
| A14 | 0.039888 | 0.181059 | 0.21476 | 0.231266 | −0.34151 |
| A15 | 0 | 0 | 0 | 0 | 0 |
| A16 | −0.00845 | −0.04119 | −0.05091 | −0.05594 | 0.146045 |
| A17 | 0 | 0 | 0 | 0 | 0 |
| A18 | 0 | 0 | 0 | 0 | −0.02591 |
| A19 | 0 | 0 | 0 | 0 | 0 |
| A20 | 0 | 0 | 0 | 0 | 0 |
| | S8 | S9 | S10 | S11 | S12 |
| K | 10 | −10 | −9.465857 | −7.95352 | −8.845722 |
| A3 | 0 | 0 | 0 | −0.012616 | 0.0537727 |
| A4 | −0.05577 | 0.006262 | −0.10542 | −0.150267 | −0.081507 |
| A5 | 0 | 0 | 0 | 0.0050505 | −4.72E−03 |
| A6 | 0.022658 | −0.0073 | 0.1373798 | 0.0868206 | 0.0238897 |
| A7 | 0 | 0 | 0 | 1.79E−04 | 1.17E−03 |
| A8 | −0.11364 | −0.06759 | −0.133647 | −0.044098 | −0.007196 |
| A9 | 0 | 0 | 0 | 2.19E−05 | −4.64E−05 |
| A10 | 0.2358 | 0.135352 | 0.0849918 | 0.0147699 | 0.0014669 |
| A11 | 0 | 0 | 0 | −1.40E−06 | −1.42E−06 |
| A12 | −0.258 | −0.14659 | −0.038209 | −0.003094 | −0.000203 |
| A13 | 0 | 0 | 0 | −5.43E−08 | 1.48E−07 |
| A14 | 0.159462 | 0.09631 | 0.0120525 | 0.0004048 | 1.87E−05 |
| A15 | 0 | 0 | 0 | −1.64E−08 | 7.31E−09 |
| A16 | −0.05196 | −0.03957 | −0.002545 | −3.24E−05 | −1.16E−06 |
| A17 | 0 | 0 | 0 | 4.46E−10 | 1.24E−09 |
| A18 | 0.007181 | 0.010102 | 0.0003284 | 1.45E−06 | 4.50E−08 |
| A19 | 0 | 0 | 0 | 3.15E−10 | −1.15E−10 |
| A20 | 0 | −1.54E−03 | −2.07E−05 | −2.82E−08 | −8.35E−10 |

Various aberrations in Numerical example 5 above are shown in FIG. 10. As can be clearly seen from the respective aberration diagrams, various aberrations are favorably corrected while compactness is achieved, and superior optical performance is achieved accordingly.

### Numerical Example 6

In the imaging lens 6 illustrated in FIG. 11, the first lens L1 has positive refractive power, and has an object-sided surface that is a convex surface. The second lens L2 has negative refractive power near the optical axis, and has an image-sided surface that is a concave surface. The third lens L3 has an object-sided surface that is a convex surface near the optical axis. Also, the third lens L3 has positive refractive power near the optical axis. The fourth lens L4 has negative refractive power near the optical axis. The fifth lens L5 has positive refractive power near the optical axis.

Lens data of Numerical example 6 in which specific numerical values are applied to the imaging lens 6 is shown in Table 11 together with values of the total focal length f of the lens system, the F-number, and the half angle of view ω. In the imaging lens 6, both surfaces of each of the first lens L1 to the fifth lens L5 are formed to be aspherical surfaces. Values of aspherical surface coefficients A3 to A20 in those aspherical surfaces are shown in Table 12 together with the values of the coefficient K.

TABLE 11
f = 3.28 mm
Fno = 1.96
ω = 37.64°
Example 6

| Lens | Si | Ri | Di | Ndi | νdi |
|---|---|---|---|---|---|
| (Virtual | 1 | ∞ | 0.149 | | |
| surface) | | | | | |
| (St) | 2(STO) | ∞ | −0.149 | | |
| L1 | 3(ASP) | 1.8569 | 0.602 | 1.535 | 56.27 |
| | 4(ASP) | −4.3306 | 0.031 | | |
| L2 | 5(ASP) | 5.7776 | 0.340 | 1.634 | 23.87 |
| | 6(ASP) | 1.5587 | 0.415 | | |
| L3 | 7(ASP) | 4.8010 | 0.570 | 1.535 | 56.27 |
| | 8(ASP) | −12.8693 | 0.324 | | |
| L4 | 9(ASP) | −0.7552 | 0.340 | 1.550 | 36.00 |
| | 10(ASP) | −0.8704 | 0.021 | | |
| L5 | 11(ASP) | 1.2191 | 0.667 | 1.535 | 56.27 |
| | 12(ASP) | 0.9976 | 0.320 | | |
| (SG) | 13 | ∞ | 0.110 | 1.5120 | 56.90 |
| | 14 | ∞ | 0.651 | | |
| (IMG) | 15 | ∞ | | | |

TABLE 12
Example 6

| | S3 | S4 | S5 | S6 | S7 |
|---|---|---|---|---|---|
| K | −1.32952 | 9.993407 | 5.193427 | −8.40485 | 9.999997 |
| A3 | 0 | 0 | −0.00305 | 0.012456 | −0.04845 |
| A4 | 0.003214 | 0.111774 | 0.031671 | 0.099739 | 0.097361 |
| A5 | 0 | 0 | −0.05789 | 0.084074 | −0.27784 |
| A6 | −0.03635 | −0.2151 | 0.064021 | −0.15363 | 0.142269 |
| A7 | 0 | 0 | 0.036592 | 0.065897 | 0.100572 |
| A8 | 0.019502 | 0.127714 | −0.22365 | −0.00247 | −0.0613 |
| A9 | 0 | 0 | 0.039377 | 0.036842 | −0.11154 |
| A10 | −0.06144 | −0.05398 | 0.23492 | −0.01237 | 0.011128 |
| A11 | 0 | 0 | −0.08302 | 0 | 0.054016 |
| A12 | 0 | 0.000881 | −0.02841 | 0 | 0 |
| A13 | 0 | 0 | 0 | 0 | 0 |
| A14 | 0 | 0 | 0 | 0 | 0 |
| A15 | 0 | 0 | 0 | 0 | 0 |
| A16 | 0 | 0 | 0 | 0 | 0 |
| A17 | 0 | 0 | 0 | 0 | 0 |
| A18 | 0 | 0 | 0 | 0 | 0 |
| A19 | 0 | 0 | 0 | 0 | 0 |
| A20 | 0 | 0 | 0 | 0 | 0 |
| | S8 | S9 | S10 | S11 | S12 |
| K | 8.8101509 | −0.70191 | −4.062986 | −0.653602 | −5.858834 |
| A3 | −0.008944 | 0.131938 | −0.302312 | −0.359304 | 0.0104118 |
| A4 | −0.156033 | 0.081254 | −0.094491 | 0.0679648 | −0.124868 |
| A5 | 0.221551 | −0.15742 | 0.2010627 | 0.0075655 | 9.85E−02 |
| A6 | −0.075735 | 0.306206 | 0.0963046 | −0.000207 | −0.033911 |
| A7 | −0.162874 | 0.113948 | −0.005645 | −1.84E−02 | 5.73E−03 |
| A8 | 0.0239849 | −0.05829 | −0.023608 | −0.00427 | −0.003845 |
| A9 | 0.1067401 | −7.79E−02 | 1.51E−03 | 2.52E−03 | 1.02E−03 |
| A10 | 0.0664714 | −0.00832 | −0.004336 | 0.0008997 | 0.0001324 |
| A11 | −0.018739 | 7.02E−03 | −4.69E−03 | 9.07E−04 | −1.46E−04 |
| A12 | −0.041181 | 0.012227 | −0.004141 | 2.98E−05 | 0.0001044 |
| A13 | −0.147609 | 0 | 4.05E−03 | 1.21E−05 | −1.84E−05 |
| A14 | 0.0524315 | 0 | 0 | −0.000117 | −3.57E−06 |
| A15 | 0.1473368 | 0 | 0 | 0 | 1.52E−06 |
| A16 | −0.080672 | 0 | 0 | 0 | 2.33E−06 |
| A17 | 0 | 0 | 0 | 0 | −1.44E−06 |
| A18 | 0 | 0 | 0 | 0 | −3.11E−07 |
| A19 | 0 | 0 | 0 | 0 | −5.59E−10 |
| A20 | 0 | 0 | 0 | 0 | 8.03E−08 |

Various aberrations in Numerical example 6 above are shown in FIG. 12. As can be clearly seen from the respective aberration diagrams, various aberrations are favorably corrected while compactness is achieved, and superior optical performance is achieved accordingly.

### Other Numerical Data in Respective Examples

Table 13 shows summary of values related to the respective conditional expressions described above for the respective numerical examples. As can be seen from Table 13, the values in the respective numerical examples are within the numerical ranges thereof for the respective conditional expressions. Also, Table 14 shows summary of the values of the focal lengths f1 to f5 of the respective lenses L1 to L5.

TABLE 13

| Conditional | Exam- | Exam- | Exam- | Exam- | Exam- | Exam- |
|---|---|---|---|---|---|---|
| expression | ple 1 | ple 2 | ple 3 | ple 4 | ple 5 | ple 6 |
| ν4 | 23.870 | 23.870 | 23.870 | 22.456 | 22.870 | 36.000 |
| ΣD/f | 1.280 | 1.301 | 1.237 | 1.093 | 1.175 | 1.338 |
| (r₃₁ + r₃₂)/ | 0.9136 | 0.9884 | 0.0080 | 0.8592 | 0.6100 | −0.4566 |
| (r₃₁ − r₃₂) | | | | | | |
| f/f4 | −0.472 | −0.427 | −0.252 | −0.568 | −0.283 | 0.015 |
| f2/f1 | −1.471 | −1.388 | −1.573 | −1.861 | −1.528 | −1.381 |
| r₅₁/f | 0.284 | 0.269 | 0.235 | 0.277 | 0.445 | 0.372 |

TABLE 14

| Focal | Exam- | Exam- | Exam- | Exam- | Exam- | Exam- |
|---|---|---|---|---|---|---|
| length | ple 1 | ple 2 | ple 3 | ple 4 | ple 5 | ple 6 |
| f1 | 2.4956 | 2.3304 | 2.2525 | 3.2229 | 3.1057 | 2.5163 |
| f2 | −3.6709 | −3.2354 | −3.5439 | −5.9971 | −4.7461 | −3.4743 |
| f3 | 9.8899 | 10.8603 | 53.2187 | 23.4104 | 17.7632 | 6.615 |
| f4 | −7.1035 | −7.839 | −12.5184 | −8.3953 | −16.8414 | 219.9701 |
| f5 | 7.0843 | 7.2048 | 6.7518 | 38.9048 | 694.6532 | 212.9138 |

### 5. Other Embodiments

The technology of the present disclosure is not limited to the description of the embodiments and Examples above, and may be variously modified. For example, the shape and the numerical value of each of the sections described above in the respective numerical examples are mere examples for embodying the present technology. The technical range of the present technology should not be limitedly construed based thereon.

Moreover, in the embodiment and Examples above, description has been provided of the configuration substantially configured of five lenses. However, there may be adopted a configuration that further includes a lens that substantially has no refractive power.

Moreover, it is possible to achieve at least the following configurations from the above-described example embodiments and the modifications of the disclosure.

[1]

An imaging lens including:

a first lens having positive refractive power;

a second lens having negative refractive power near an optical axis;

a third lens having an object-sided surface that is a convex surface near the optical axis, the third lens having positive refractive power near the optical axis;

a fourth lens having one of positive refractive power and negative refractive power near the optical axis; and

a fifth lens having positive refractive power near the optical axis,

the first to fifth lenses being arranged in order from an object side, wherein

the following Conditional expression (1) is satisfied,

v4<40 (1)

where v4 is an Abbe number of the fourth lens.

[2]

The imaging lens according to [1], wherein the following Conditional expression (2) is satisfied,

1.0<ΣD/f<1.5 (2)

where ΣD is a distance on the optical axis from a vertex of an object-sided surface of the first lens to image plane, and

f is a total focal length of the imaging lens.

[3]

The imaging lens according to [1] or [2], wherein the following Conditional expression (2)′ is satisfied.

1.0<ΣD/f<1.4 (2)′

[4]

The imaging lens according to any one of [1] to [3], wherein the following Conditional expression (3) is satisfied,

−1.0<(r₃₁+r₃₂)/(r₃₁−r₃₂)<1.5 (3)

where r₃₁ is a center curvature radius of the object-sided surface of the third lens, and

r₃₂ is a center curvature radius of an image-sided surface of the third lens.

[5]

The imaging lens according to any one of [1] to [4], wherein the following Conditional expression (4) is satisfied,

−0.625<f/f4<0.1 (4)

where f4 is a focal length of the fourth lens.

[6]

The imaging lens according to any one of [1] to [5], wherein the following Conditional expression (5) is satisfied,

−2.1<f2/f1<−1.2 (5)

where f1 is a focal length of the first lens, and

f2 is a focal length of the second lens.

[7]

The imaging lens according to any one of [1] to [6], wherein the following Conditional expression (6) is satisfied,

0.2<r₅₁/f<0.5 (6)

where r₅₁ is a center curvature radius of an object-sided surface of the fifth lens.

[8]

The imaging lens according to any one of [1] to [7], wherein the fifth lens has an image-sided surface that is an aspherical surface having a concave shape near the optical axis and having a convex shape in a peripheral portion thereof.

[9]

The imaging lens according to any one of [1] to [8], wherein

the first lens has an object-sided surface that is a convex surface, and

the second lens has an image-sided surface that is a concave surface.

[10]

The imaging lens according to any one of [1] to [9], further including a lens having substantially no refractive power.

[11]

An imaging unit including:

an imaging lens; and

an imaging device configured to output an imaging signal based on an optical image formed by the imaging lens,

the imaging lens including

a first lens having positive refractive power,

a second lens having negative refractive power near an optical axis,

a third lens having an object-sided surface that is a convex surface near the optical axis, the third lens having positive refractive power near the optical axis,

a fourth lens having one of positive refractive power and negative refractive power near the optical axis, and

a fifth lens having positive refractive power near the optical axis,

the first to fifth lenses being arranged in order from an object side, wherein

the following Conditional expression (1) is satisfied,

v4<40 (1)

where v4 is an Abbe number of the fourth lens.

[12]

The imaging unit according to [11], wherein the imaging lens further includes a lens having substantially no refractive power.

It should be understood by those skilled in the art that various modifications, combinations, sub-combinations, and alterations may occur depending on design requirements and other factors insofar as they are within the scope of the appended claims or the equivalents thereof.

What is claimed is:

1. An imaging lens comprising:
a first lens having positive refractive power;
a second lens having negative refractive power near an optical axis;
a third lens having an object-sided surface that is a convex surface near the optical axis, the third lens having positive refractive power near the optical axis;
a fourth lens having one of positive refractive power and negative refractive power near the optical axis; and
a fifth lens having positive refractive power near the optical axis, the first to fifth lenses being arranged in order from an object side, wherein
the following Conditional expression (1) is satisfied,
v4<40 (1)
where v4 is an Abbe number of the fourth lens.

2. The imaging lens according to claim 1, wherein the following Conditional expression (2) is satisfied,
1.0<ΣD/f<1.5 (2)
where ΣD is a distance on the optical axis from a vertex of an object-sided surface of the first lens to image plane, and
f is a total focal length of the imaging lens.

3. The imaging lens according to claim 2, wherein the following Conditional expression (2)′ is satisfied.
1.0<ΣD/f<1.4 (2)′

4. The imaging lens according to claim 1, wherein the following Conditional expression (3) is satisfied,
−1.0<(r₃₁+r₃₂)/(r₃₁−r₃₂)<1.5 (3)
where r₃₁ is a center curvature radius of the object-sided surface of the third lens, and
r₃₂ is a center curvature radius of an image-sided surface of the third lens.

5. The imaging lens according to claim 1, wherein the following Conditional expression (4) is satisfied,
−0.625<f/f4<0.1 (4)
where f4 is a focal length of the fourth lens.

6. The imaging lens according to claim 1, wherein the following Conditional expression (5) is satisfied,
−2.1<f2/f1<−1.2 (5)
where f1 is a focal length of the first lens, and
f2 is a focal length of the second lens.

7. The imaging lens according to claim 1, wherein the following Conditional expression (6) is satisfied,
0.2 <r₅₁/f<0.5 (6)
where r₅₁ is a center curvature radius of an object-sided surface of the fifth lens.

8. The imaging lens according to claim 1, wherein the fifth lens has an image-sided surface that is an aspherical surface having a concave shape near the optical axis and having a convex shape in a peripheral portion thereof.

9. The imaging lens according to claim 1, wherein
the first lens has an object-sided surface that is a convex surface, and
the second lens has an image-sided surface that is a concave surface.

10. An imaging unit comprising:
an imaging lens; and
an imaging device configured to output an imaging signal based on an optical image formed by the imaging lens,
the imaging lens including
a first lens having positive refractive power,
a second lens having negative refractive power near an optical axis,
a third lens having an object-sided surface that is a convex surface near the optical axis, the third lens having positive refractive power near the optical axis,
a fourth lens having one of positive refractive power and negative refractive power near the optical axis, and
a fifth lens having positive refractive power near the optical axis, the first to fifth lenses being arranged in order from an object side, wherein
the following Conditional expression (1) is satisfied,
v4 <40 (1)
where v4 is an Abbe number of the fourth lens.
